(19) United States
(12) Patent Application Publication
(10) Pub. No.: US 2026/0134677 A1
(43) Pub. Date: May 14, 2026

(54) ESTABLISHMENT AND COMPARISON METHOD OF KNOWLEDGE GRAPH

(71) Applicant: FENG CHIA UNIVERSITY, Taichung City (TW)

(72) Inventors: Wei-Lun LIN, Taichung City (TW); Wen Wuu CHAN, Taichung City (TW)

(73) Assignee: FENG CHIA UNIVERSITY, Taichung City (TW)

(21) Appl. No.: 18/988,178

(22) Filed: Dec. 19, 2024

(30) Foreign Application Priority Data
Nov. 11, 2024 (TW) 113143131

(51) Int. Cl. G06V 10/86; G06V 10/25; G06V 10/74; G06V 10/82

(52) U.S. Cl. CPC G06V 10/86; G06V 10/25; G06V 10/761; G06V 10/82

(57) ABSTRACT

An establishment and comparison method of knowledge graph comprises: recognizing an under-test image through an object recognition model to generate multiple bounding boxes, establishing an under-test knowledge graph of the under-test image according to the multiple bounding boxes, establishing relationships between the under-test knowledge graph and a known knowledge graph group, computing a major sort node value of each known knowledge graph in the known knowledge graph group according to the relationships between the under-test knowledge graph and the known knowledge graph group, and inputting the major sort node value of each known knowledge graph into a SoftMax function to compute multiple total relevance weighted values between the under-test knowledge graph and each known knowledge graph.

### CROSS REFERENCE TO RELATED APPLICATIONS

The present application claims priority to Taiwan application No. 113143131, filed on November 11, 2024, the content of which is hereby incorporated by reference in its entirety.

### BACKGROUND OF THE INVENTION

### 1. Field of the Invention

The present invention relates to neural network technology, especially a method for establishing an unknown graph and comparing the unknown graph with other knowledge graphs.

### 2. Description of the Related Art

A detecting method for an under-test image of a conventional neural network is described as follows. The under-test image is inputted into a trained object recognition model. The object recognition model compares the under-test image with a large amount of data stored therein to confirm a sort of the under-test image. The detecting method includes two aspects. One aspect is to mark or separate objects with a same property in the under-test image. The other aspect is to compare the marked or separated objects with known objects in the object recognition model to establish relevancies, and to define the sort of the marked or separated objects.

However, the conventional object recognition model has problems in the aspect of object recognition. When the under-test image contains an unknown object that the object recognition model cannot recognize, the object recognition model fails to establish relevancies between the unknown object and the known objects that the object recognition model can recognize. The unknown object needs to be manually labeled to classify the under-test image. For example, the under-test image has three objects. It is assumed that the object recognition model only recognizes two of the three objects in the under-test image, as the remaining object is an unrecognizable object. The remaining object is the unknown object (unrecognizable object) for the object recognition model. Since the conventional object recognition model cannot understand that the under-test image contains unknown objects, the conventional object recognition model naturally will not take any action on the unknown objects. Therefore, the under-test image cannot be accurately identified by the conventional object recognition model.

### SUMMARY OF THE INVENTION

When the conventional object recognition model recognizes an under-test image with unknown objects, the conventional object recognition model cannot establish relationships between the said unknown objects and known objects that the object recognition model can recognize, so that the conventional object recognition model will not take any action on the unknown objects. In view of this, the present invention provides an establishment and comparison method of knowledge graph, executed by a detecting apparatus and comprising:

recognizing an under-test image through an object recognition model to generate multiple bounding boxes;

establishing an under-test knowledge graph corresponding to the under-test image according to the multiple bounding boxes, wherein the under-test knowledge graph comprises multiple property nodes, and the multiple property nodes respectively correspond to the multiple bounding boxes;

establishing relationships between the under-test knowledge graph and a known knowledge graph group, wherein the known knowledge graph group comprises multiple known knowledge graphs, and each known knowledge graph has a major sort node value;

computing the major sort node value of each known knowledge graph according to the relationships between the under-test knowledge graph and the known knowledge graph group; and

inputting the major sort node value of each known knowledge graph into a SoftMax function to compute multiple total relevance weighted values between the under-test knowledge graph and each known knowledge graph.

When the object recognition model recognizes the under-test image that may include an unknown object, the method of the present invention can establish relevancies between the under-test knowledge graph corresponding to the under-test image and each known knowledge graph according to the multiple total relevance weighted values, thereby enabling the neural network to understand potential relationships between the under-test image and each known knowledge graph and can perform subsequent processes.

### BRIEF DESCRIPTION OF THE DRAWINGS

FIG. 1 is a circuit block diagram of a detecting apparatus of an establishment and comparison method of knowledge graph of the present invention;

FIG. 2 is a flow chart of the establishment and comparison method of knowledge graph of the present invention;

FIG. 3 is a schematic diagram of an under-test knowledge graph of the establishment and comparison method of knowledge graph of the present invention;

FIG. 4 is a schematic diagram depicting the under-test knowledge graph and a known knowledge graph of the establishment and comparison method of knowledge graph of the present invention;

FIG. 5 is a flow chart of the establishment and comparison method of knowledge graph of the present invention;

FIG. 6 is a schematic diagram depicting the under-test knowledge graph and a known knowledge graph group of the establishment and comparison method of knowledge graph of the present invention, wherein at least two of multiple relevance weighted edges are jointly connected with one of multiple sort nodes;

FIG. 7 is a schematic diagram of a sort node algorithm of the establishment and comparison method of knowledge graph of the present invention; and

FIG. 8 is a schematic diagram of a computation for a value of a sort node of the establishment and comparison method of knowledge graph of the present invention, wherein the sort node is connected with a sort weighted edge and a relevance weighted edge at the same time.

### DETAILED DESCRIPTION OF THE INVENTION

In order to understand the technical characteristics and practical effects of the prevent invention in detail, and accomplish them according to the content of the present invention, the detailed description is as follows with the embodiments shown in the figures.

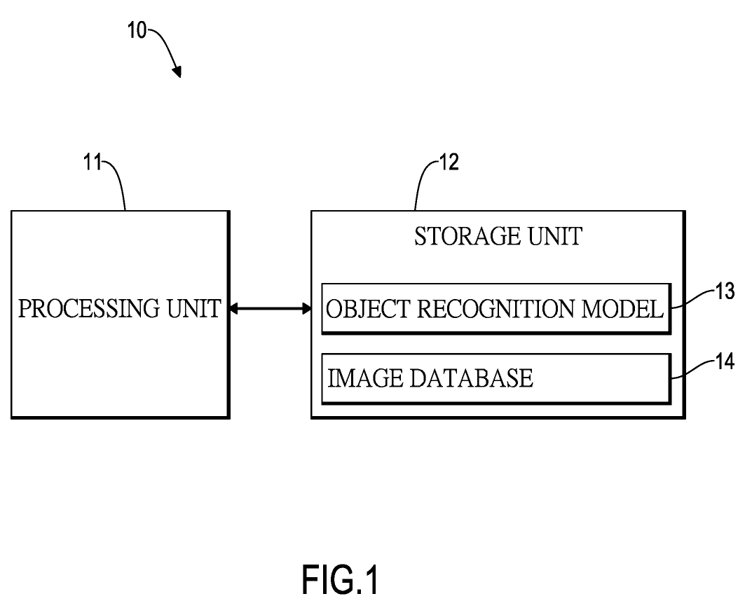

Referring to FIG. 1, an establishment and comparison method of knowledge graph of the present invention is executed by a detecting apparatus 10. The detecting apparatus 10 comprises a processing unit 11 and a storage unit 12. The processing unit 11 is connected to the storage unit 12. The processing unit 11 can read data from the storage unit 12 and write data into the storage unit 12. For example, the processing unit 11 may be a Central Processing Unit (CPU), a Graphics Processing Unit (GPU), a Digital Signal Processing (DSP), or other data processing devices. The storage unit 12 stores a program code of an object recognition model 13 and an image database 14. The object recognition model 13 is connected with the image database 14. The processing unit 11 can read the data in the image database 14 and execute the program code of the object recognition model 13. In particular, the processing unit 11 executes the object recognition model 13 according to the data in the image database 14 and write executing results of the object recognition model 13 into the image database 14. For example, the storage unit 12 may be a hard disk, a memory, a Network Attached Storage (NAS), or other storage devices. The processing unit 11 and the storage unit 12 of the present invention are not limited to the foregoing examples.

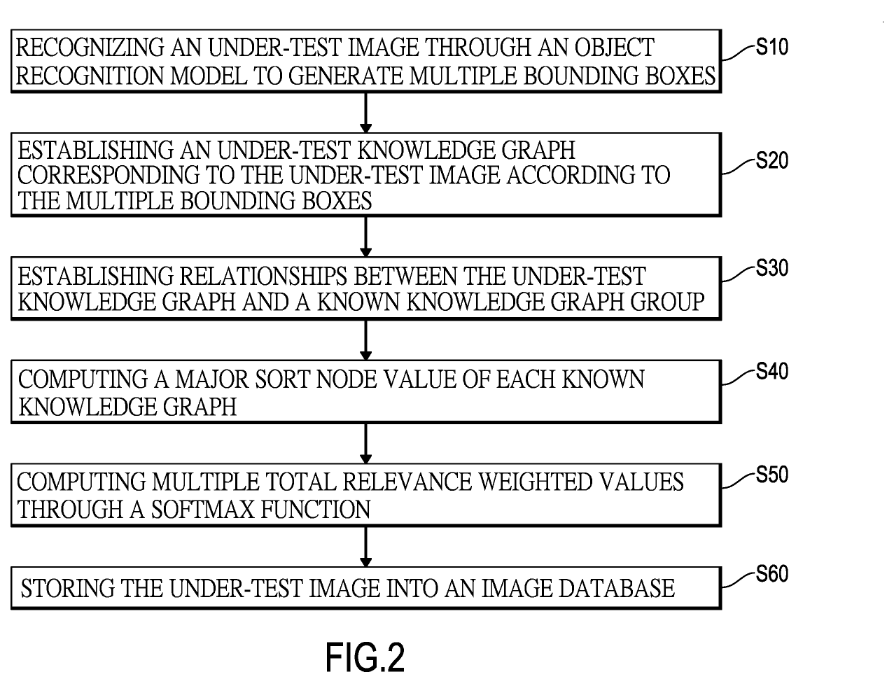

Referring to FIG. 2, the establishment and comparison method of knowledge graph comprises steps S10 to S60, each step described as follows.

Step S10: the step is to recognize an under-test image through the object recognition model 13 to generate multiple bounding boxes. In particular, the processing unit 11 receives the under-test image. For example, the under-test image is pre-stored in the storage unit 12, and the processing unit 11 reads (receives) the under-test image stored in the storage unit 12 to perform subsequent object recognizing computations. Or the processing unit 11 has an input/output interface to receive the under-test image from an external device to the detecting apparatus 10 and output computing results. For example, the input/output interface may be an Inter-Integrated Circuit (I²C), a Serial Peripheral Interface Bus (SPI), etc. The present invention is not limited to the foregoing examples. Then, the processing unit 11 reads and executes the program code of the object recognition model 13. The object recognition model 13 can perform image segmentation on the under-test image. That is, the object recognition model 13 classifies multiple pixels in the under-test image to generate the multiple bounding boxes, and a pixel set in each bounding box is an under-test object.

The object recognition model 13 generates the multiple bounding boxes based on features such as texture, color, edge shape, and size, etc. in the under-test image. The object recognition model 13 is a neural network model used to recognize images. For example, the object recognition model 13 may be a neural network model of region-proposal-based deep learning (such as Region-based Convolutional Neural Network (R-CNN) and Region-based Fully Convolutional Neural Network (R-FCN)) or recursion-based deep learning (such as You Only Look Once (YOLO) and Single Shot Multibox Detector (SSD)). The present invention is not limited to the foregoing examples.

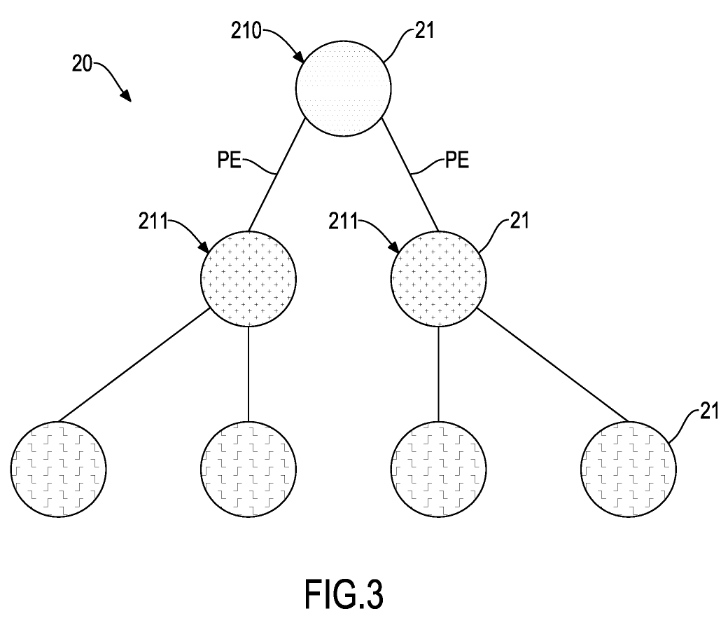

Step S20: the step is to establish an under-test knowledge graph corresponding to the under-test image according to the multiple bounding boxes. In particular, the processing unit 11 establishes an under-test knowledge graph 20 as shown in FIG. 3 according to the multiple bounding boxes generated by the object recognition model 13. The under-test knowledge graph 20 comprises multiple property nodes 21. The multiple property nodes 21 respectively correspond to the multiple bounding boxes. For example, a content of the under-test image is a cat. The multiple bounding boxes respectively select under-test objects including the entire cat, the cat’s eyes, the cat’s body, and the cat’s paws, etc. And the multiple property nodes 21 correspond to the said under-test objects. Preferably, before establishing the under-test knowledge graph 20, the object recognition model 13 can eliminate redundant bounding boxes through a Non-Maximum Suppression (NMS) algorithm.

Referring to FIG. 3, the multiple property nodes 21 are connected as a Hierarchical Data Tree. The multiple property nodes 21 comprise a major property node 210 and at least one minor property node 211. The major property node 210 is connected with each minor property node 211 through a property weighted edge PE respectively. A value of each property weighted edge PE is a reciprocal of a number of the at least one minor property node 211 connected to the major property node 210. For example, the property node 21 in a topmost level of the under-test knowledge graph 20 is the major property node 210. The major property node 210 is connected with two of the minor property nodes 211. The values of the property weighted edges PE between the major property node 210 and the two of the minor property nodes 211 respectively are 1/2 (the number of at least one minor property node 211 is 2, and the reciprocal of 2 is 1/2). The major property node 210 can correspond to the entire cat, one minor property node 211 can correspond to the cat’s head, and the other minor property node 211 can correspond to the cat’s body.

In the under-test knowledge graph 20, except that the property node 21 at a lowest level cannot be defined as the major property node 210, the property node 21 in other layers can be defined as the major property node 210. For example, assuming the property node 21 corresponding to the cat’s body as the major property node 210, the at least one minor property node 211 connected with the major property node 210 corresponds to the cat’s paws. A number of levels of the under-test knowledge graph 20 can be determined by the number of the multiple bounding boxes, and the present invention is not limited to the foregoing example.

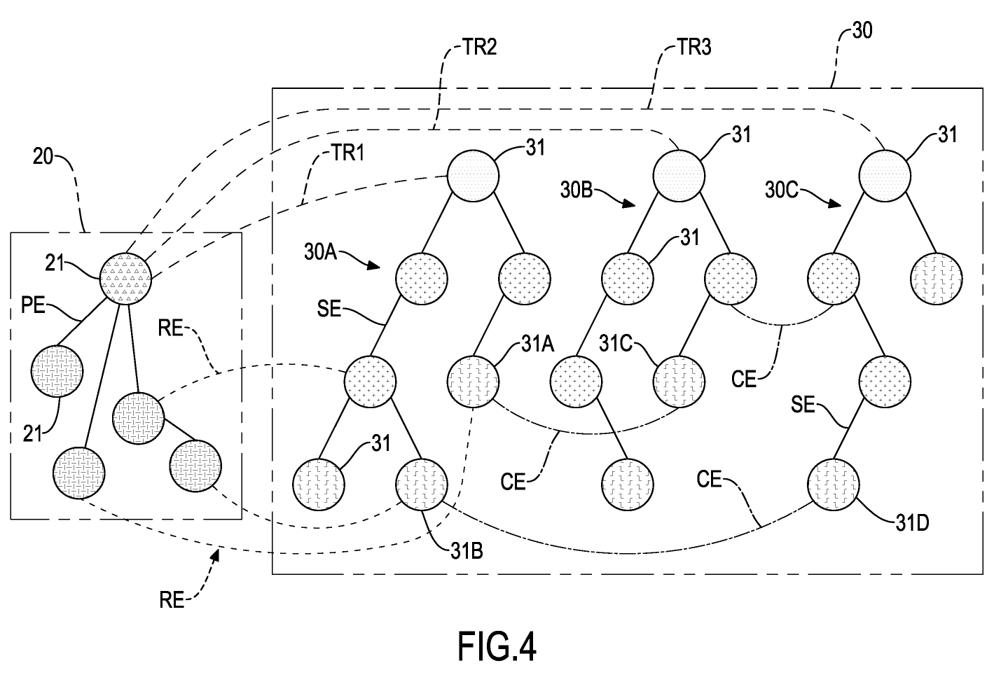

Step S30: the step is to establish relationships between the under-test knowledge graph 20 and a known knowledge graph group. Specifically, referring to FIG. 4, the processing unit 11 reads a known knowledge graph group 30 from the storage unit 12. The known knowledge graph group 30 comprises multiple known knowledge graphs. For example, the multiple known knowledge graphs respectively are a first known knowledge graph 30A, a second known knowledge graph 30B, and a third known knowledge graph 30C. Each known knowledge graph comprises multiple sort nodes 31, and the multiple sort nodes 31 are also connected as a Hierarchical Data Tree. Each known knowledge graph has a major sort node value, and the major sort node value is a value of the sort node 31 in the topmost level of each known knowledge graph.

A principle to establish the known knowledge graph group 30 is substantially same as the principle to establish the under-test knowledge graph 20 by the under-test image as mentioned above. In short, the image database 14 stores multiple known images. The processing unit 11 reads each known image and executes the object recognition model 13. The object recognition model 13 recognizes each known image to generate multiple bounding boxes of each known image. The processing unit 11 establishes the known knowledge graph corresponding to each known image according to the multiple bounding boxes of each known image, and stores the known knowledge graph of each known image to the storage unit 12. Therefore, the processing unit 11 can read the known knowledge graph of each known image from the storage unit 12.

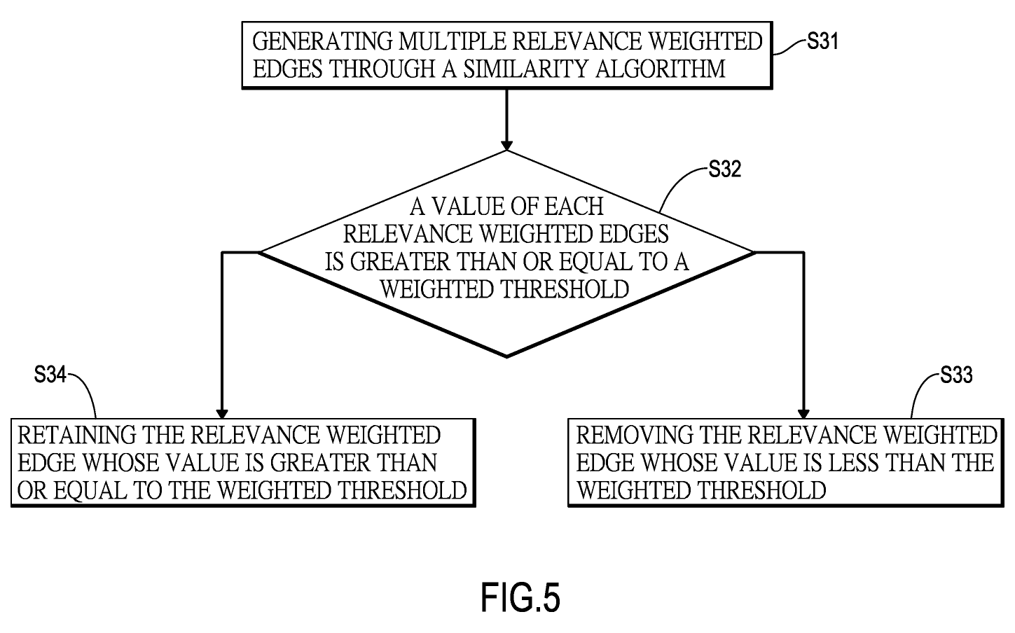

The processing unit 11 can establish the relationships between the under-test knowledge graph 20 and the known knowledge graph group 30 through sub-steps shown in FIG. 5.

Sub-step S31: the processing unit 11 generates multiple relevance weighted edges RE between the under-test knowledge graph 20 and one of the multiple known knowledge graphs through a similarity algorithm. In particular, each relevance weighted edge RE is connected between one of the multiple sort nodes 31 and one of the multiple property nodes 21. For example, referring to FIG. 4, three of the property nodes 21 in the under-test knowledge graph 20 are respectively connected with three of the sort nodes 31 in the first known knowledge graph 30A. The similarity algorithm can be a Cosine Similarity algorithm, a Kullback-Leibler divergence (KLD) algorithm, etc. The present invention is not limited to the foregoing examples.

Sub-step S32: the processing unit 11 determines whether a value of each relevance weighted edge RE is greater than or equal to a weighted threshold. The weighted threshold is stored in the storage unit 12, and the processing unit 11 reads the weighted threshold to perform such determination. For example, the values of the relevance weighted edges connected with the three property nodes 21 and the three sort nodes 31 are 0.75, 0.7, and 0.77, respectively. Assuming the weighted threshold is 0.7, the values of the relevance weighted edges are greater than or equal to the weighted threshold.

Sub-step S33: the processing unit 11 retains the relevance weighted edge RE whose value is greater than or equal to the weighted threshold as the relationship between the under-test knowledge graph 20 and the known knowledge graph group 30. That is, a first relevance weighted edge whose value is 0.75, a second relevance weighted edge whose value is 0.7, and a third relevance weighted edge whose value is 0.77 are connected between the under-test knowledge graph 20 and the first known knowledge graph 30A. On the contrary, when the value of a relevance weighted edge RE is less than the weighted threshold, the processing unit 11 executes the sub-step S34 to remove the relevance weighted edge RE.

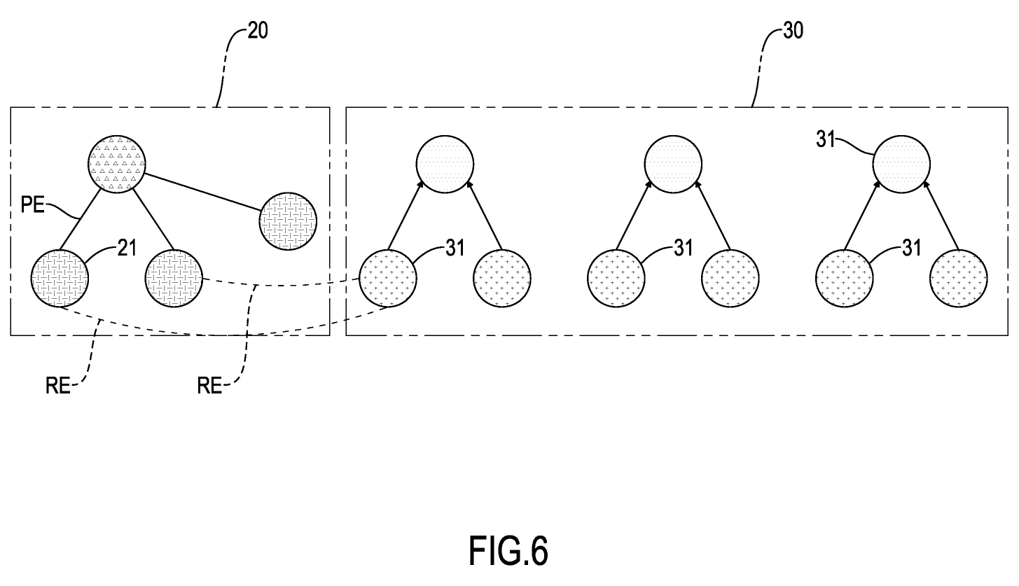

In addition, during a process of the processing unit 11 establishing the relationships between the under-test knowledge graph 20 and the known knowledge graph group, as shown in FIG. 6, when at least two of the multiple relevance weighted edges RE are jointly connected with one of the sort nodes 31, the processing unit 11 retains the relevance weighted edge RE with a greatest value among the at least two relevance weighted edges RE to establish the relationship between the under-test knowledge graph 20 and the known knowledge graph group 30, and removes other relevance weighted edges RE connected with the sort node 31. That is, one of the sort nodes 31 is only connected with one of the property nodes 21 through the relevance weighted edge RE to establish the relationship.

Step S40: the processing unit 11 computes the major sort node value of each known knowledge graph according to the relationships between the under-test knowledge graph 20 and the known knowledge graph group 30. Specifically, the step S40 includes the following sub-steps S41 to S44.

Sub-step S41: the processing unit 11 computes a temporary major sort node value of each known knowledge graph according to the values of the multiple relevance weighted edges RE, values of multiple common edges, and a sort node algorithm. In particular, referring to FIG. 4, the multiple common edges CE are connected between the multiple sort nodes 31 in the multiple known knowledge graphs. That is, one terminal of each common edge CE is connected with one of the sort nodes 31, and the other terminal of each common edge CE is connected with another one of the sort nodes 31. Moreover, the multiple sort nodes 31 in each known knowledge graph are connected through multiple sort weighted edges SE. That is, one terminal of each sort weighted edge SE is connected with one of the sort nodes 31, and the other terminal of each sort weighted edge SE is connected with another one of the sort nodes 31. The sort node algorithm is adapted to compute the values of the sort nodes 31 that are at the levels other than the lowest level in each known knowledge graph. Each value of the sort node 31 that is at the level other than the lowest level in each known knowledge graph is a value of a sum of the values of the sort nodes 31 that are connected with a bottom of the sort node 31 multiplied by a reciprocal of a number of the sort nodes 31 that the sort node 31 is connected with.

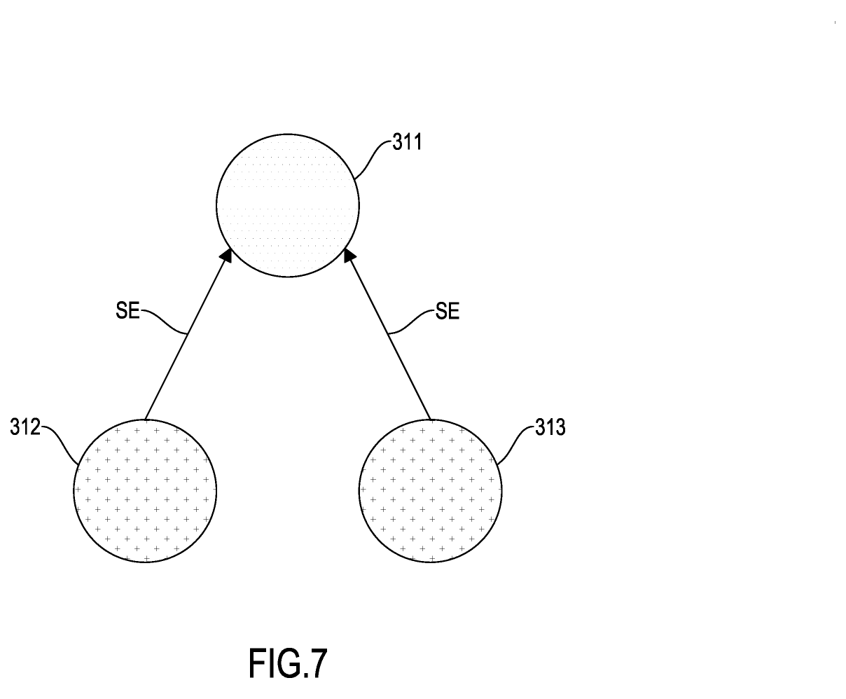

For example, referring to FIG. 7, the bottom of the first sort node 311 is connected with a second sort node 312 and a third sort node 313. The first sort node 311 and the second sort node 312 are connected through the sort weighted edge SE, and the first sort node 311 and the third sort node 313 are connected through the sort weighted edge SE. Since the number of the sort node 31 connected with the first sort node 311 is 2, the value of each sort weighted edge SE is 1/2. Therefore, the value of the first sort node 311 is a product of the value of the second sort node 312 and the value of the sort weighted edge SE plus a produce of the value of the third sort node 313 and the value of the sort weighted edge SE. That is, the value of the first sort node 311 is the sum of the value of the second sort node 312 and the value of the third sort node 313 multiplied by the value of the sort weighted edge SE (the reciprocal of the number of the sort nodes 31 of the first sort node 311 connected with).

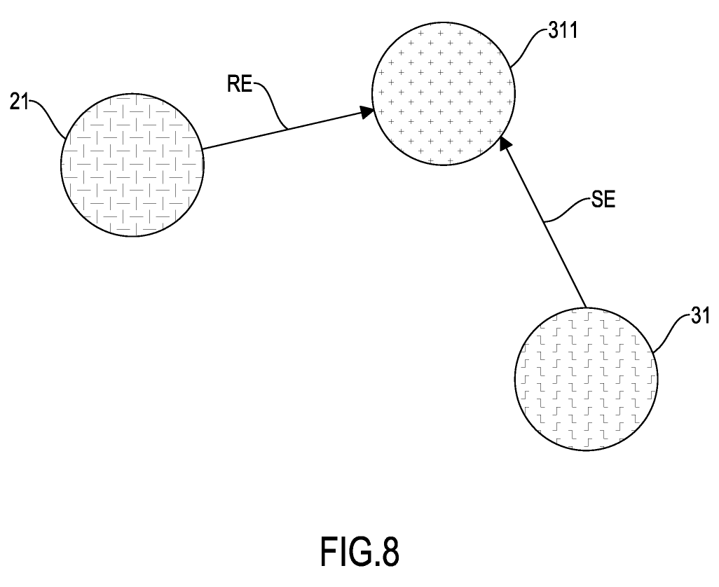

In addition, referring to FIG. 8, as mentioned above, each sort weighted edge SE has two terminals, and each relevance weighted edge RE has two terminals. When one of the multiple sort nodes 31 (such as the first sort node 311) is connected with one terminal of the sort weighted edge SE and one terminal of the relevance weighted edge RE at the same time, the value of the sort node 31 (the first sort node 311) is the greater one of a sort product and a relevance product. The sort product is the value of the sort weighted edge SE multiplied by the value of the sort node 31 connected with the other terminal of the sort weighted edge SE, and the relevance product is the value of the relevance weighted edge RE multiplied by the value of the property node 21 connected with the other terminal of the relevance weighted edge RE.

Therefore, referring to FIG. 4, the processing unit 11 computes the values of the sort nodes 31 in the first known knowledge graph 30A according to the values of the property nodes 21 in the under-test knowledge graph 20 and the values of the multiple relevance weighted edges RE, and computes the temporary major sort node value of the first known knowledge graph 30A through the sort node algorithm. The processing unit 11 also computes the values of the sort nodes 31 in the second known knowledge graph 30B and the third known knowledge graph 30C according to the values of the common edges CE that are connected between the first known knowledge graph 30A and the second known knowledge graph 30B, and further computes the temporary major sort node value of the second known knowledge graph 30B. The processing unit 11 also computes the temporary major sort node value of the third known knowledge graph 30C according to the aforementioned computation.

Sub-step S42: the processing unit 11 determines a data transmitting direction according to a magnitude of the temporary major sort node value of each known knowledge graph, wherein the data transmitting direction is from a source knowledge graph to a sink knowledge graph. The known knowledge graph with the greater temporary major sort node value is defined as the source knowledge graph, and the known knowledge graph with the smaller temporary major sort node value is defined as the sink knowledge graph.

For example, referring to FIG. 4, the first known knowledge graph 30A is connected with the second known knowledge graph 30B and the third known knowledge graph 30C through the multiple common edges CE. Assuming the temporary major sort node value of the first known knowledge graph 30A is greater than both of the temporary major sort node value of the second known knowledge graph 30B and the temporary major sort node value of the third known knowledge graph 30C after computation in sub-step S41, the first known knowledge graph 30A will be the source knowledge graph, and the second known knowledge graph 30B and the third known knowledge graph 30C will be the sink knowledge graphs.

Sub-step S43: the processing unit 11 updates the value of each sort node 31 in the sink knowledge graph according to the data transmitting direction to further compute the major sort node value of the sink knowledge graph. In particular, one terminal of each common edge is connected with a source node, and the other terminal of each common edge is connected with a sink node. The sort node 31 in the source knowledge graph is the source node, and the sort node 31 in the sink knowledge graph is the sink node. The values of the sink nodes respectively are the value of the source node multiplied by the value of the common edge connected with the source node and the sink node. The processing unit 11 computes the major sort node value of the sink knowledge graph according to the value of each sort node in the sink knowledge graph (the value of the sink node) and the sort node algorithm, and the temporary major sort node value of the source knowledge graph is defined as the major sort node value of the source knowledge graph.

For example, referring to FIG. 4, the first known knowledge graph 30A comprises a first source node 31A and a second source node 31B, the second known knowledge graph 30B comprises a first sink node 31C, and the third known knowledge graph 30C comprises a second sink node 31D. The first source node 31A is connected with the first sink node 31C through the common edge, and the second source node 31B is connected with the second source node 31D through the common edge. The value of the first sink node 31C is the value of the first source node 31A multiplied by the value of the common edge CE, and the value of the second sink node 31D is the value of the second source node 31B multiplied by the value of the common edge CE. The processing unit 11 updates the values of other sort nodes 31 in the second known knowledge graph 30B through the value of the first sink node 31C and the sort node algorithm to compute the major sort node value of the second known knowledge graph 30B. The processing unit 11 updates the values of other sort nodes 31 in the third known knowledge graph 30C through the value of the second sink node 31D and the sort node algorithm to compute the major sort node value of the third known knowledge graph 30C. The temporary major sort node value of the first known knowledge graph 30A is retained as the major sort node value of the first known knowledge graph 30A.

Sub-step S44: the processing unit 11 determines whether the common edge is connected between the sink knowledge graphs. When the common edge is connected between the sink knowledge graphs, the processing unit 11 executes the sub-step S42 again to update the major sort node value of the sink knowledge graph again. When the common edge is not connected between the sink knowledge graphs, the processing unit 11 executes a step S50 (described below) according to the major sort node value of each known knowledge graph.

Referring to FIG. 4, the common edge is connected between the second known knowledge graph 30B and the third known knowledge graph 30C. Assuming the major sort node value of the second known knowledge graph 30B is less than the major sort node value of the third known knowledge graph 30C after the computation in the sub-step S43, the third known knowledge graph 30C is defined as a new said source knowledge graph, and the second known knowledge graph 30B is defined as a new sink knowledge graph. The processing unit 11 executes the sub-step S42 again to update or retain the major sort node value of the second known knowledge graph 30B and the major sort node value of the third known knowledge graph 30C respectively.

Step S50: the processing unit 11 inputs the major sort node value of each known knowledge graph into a SoftMax function to compute multiple total relevance weighted values between the under-test knowledge graph 20 and each known knowledge graph. In particular, referring to FIG. 4, the property node 21 in the topmost level of the under-test knowledge graph 20 is connected with the sort node 31 in the topmost level of the first known knowledge graph 30A through a first total relevance weighted edge TRE1. The property node 21 in the topmost level of the under-test knowledge graph 20 is connected with the sort node 31 in the topmost level of the second known knowledge graph 30B through a second total relevance weighted edge TRE2. The property node 21 in the topmost level of the under-test knowledge graph 20 is connected with the sort node 31 in the topmost level of the third known knowledge graph 30C through a third total relevance weighted edge TRE3. Values of the first total relevance weighted edge TRE1, the second total relevance weighted edge TRE2 and the third total relevance weighted edge TRE3 are the multiple relevance weighted values. Since a corresponding domain of the SoftMax function is 0 to 1, each multiple total relevance weighted value is a value from 0 to 1.

Subsequently, the processing unit 11 may also execute a step S60. In the step S60, the processing unit 11 determines a value interval to which the under-test image belongs according to the multiple total relevance weighted values, and stores the under-test image into a specified directory corresponding to the value interval in the image database 14. Specifically, the image database 14 can generate multiple value intervals according to the corresponding domain of the SoftMax function. For example, the image database 14 divides the value 0 to 1 into ten value intervals. That is, a first value interval corresponds to the value 0 to 0.099, a second value interval corresponds to the value 0.1 to 0.199, … a tenth value interval corresponds to the value 0.9 to 0.999. When the total relevance weighted value is between an upper limit and a lower limit of one of the multiple value intervals, the total relevance weighted value is within the value interval.

As mentioned above, after the processing unit 11 computes from the step S10 to the step S50, assuming the total relevance weighted value of the first total relevance weighted edge TRE1 is 0.698, the total relevance weighted value of the second total relevance weighted edge TRE2 is 0.144, and the total relevance weighted value of the third total relevance weighted edge TRE3 is 0.158, the under-test knowledge graph 20 has a highest relevance with the first known knowledge graph 30A. The under-test image corresponding to the under-test knowledge graph 20 will be stored into the specified directory in the image database 14 corresponding to a seventh value interval (the value 0.6~0.7), and the specified directory also corresponds to the first known knowledge graph 30A.

The establishment and comparison method of knowledge graph of the present invention is implemented by a processing unit 11. The processing unit 11 executes an object recognition model 13, and the object recognition model 13 recognizes an under-test image to generate multiple bounding boxes. The processing unit 11 establishes an under-test knowledge graph 20 of the under-test image according to the processing unit 11, and established relationships between the under-test knowledge graph 20 and a known knowledge graph group 30. The processing unit 11 computes a major sort node value of each known knowledge graph in the known knowledge group 30 according to the relationships between the under-test knowledge graph 20 and a known knowledge graph group 30, and inputs the major sort node value of each known knowledge graph into a SoftMax function to compute multiple total relevance weighted values between the under-test knowledge graph 20 and each known knowledge graph. When the object recognition model 13 recognizes the under-test image 20 that may include an unknown object, the method of the present invention can establish relevancies between the under-test knowledge graph 20 corresponding to the under-test image and each known knowledge graph according to the multiple total relevance weighted values, thereby enabling the neural network to understand potential relationships between the under-test image and each known knowledge graph and can perform subsequent processes, such as the processing unit 11 can store the under-test image into a specified directory in the image database 14.

The above only records the implementations or embodiments of the technical artifices adopted by the present invention to solve the problems, and is not configured to limit the claims of the present invention. That is, all equivalent changes and modifications that are consistent with the meaning of the claims of the present invention or made in accordance with the claims of the present invention are covered by the claims of the present invention.

What is claimed is:

1. An establishment and comparison method of knowledge graph, executed by a detecting apparatus and comprising:
recognizing an under-test image through an object recognition model to generate multiple bounding boxes;
establishing an under-test knowledge graph corresponding to the under-test image according to the multiple bounding boxes, wherein the under-test knowledge graph comprises multiple property nodes, and the multiple property nodes respectively correspond to the multiple bounding boxes;
establishing relationships between the under-test knowledge graph and a known knowledge graph group, wherein the known knowledge graph group comprises multiple known knowledge graphs, and each known knowledge graph has a major sort node value;
computing the major sort node value of each known knowledge graph according to the relationships between the under-test knowledge graph and the known knowledge graph group; and
inputting the major sort node value of each known knowledge graph into a SoftMax function to compute multiple total relevance weighted values between the under-test knowledge graph and each known knowledge graph.

2. The establishment and comparison method as claimed in claim 1, further comprising:
determining a value interval to which the under-test image belongs according to the multiple total relevance weighted values, and storing the under-test image into a specified directory corresponding to the value interval in an image database.

3. The establishment and comparison method as claimed in claim 1, wherein:
the multiple property nodes comprise a major property node and at least one minor property node;
the major property node is connected with each minor property node through a property weighted edge respectively; and
a value of each property weighted edge is a reciprocal of a number of the at least one minor property node connected to the major property node.

4. The establishment and comparison method as claimed in claim 1, wherein:
each known knowledge graph comprises multiple sort nodes;
the multiple sort nodes of each known knowledge graph are connected as a Hierarchical Data Tree; and
the multiple property nodes in the under-test knowledge graph are connected as the Hierarchical Data Tree.

5. The establishment and comparison method as claimed in claim 1, wherein:
generating multiple relevance weighted edges between the under-test knowledge graph and one of the multiple known knowledge graphs through a similarity algorithm;
determining whether a value of each relevance weighted edge is greater than or equal to a weighted threshold; and
retaining the relevance weighted edge whose value is greater than or equal to the weighted threshold as the relationship between the under-test knowledge graph and the known knowledge graph group; and
wherein each known knowledge graph comprises multiple sort nodes, and each relevance weighted edge is connected with one of the multiple sort nodes and one of the multiple property nodes.

6. The establishment and comparison method as claimed in claim 5, wherein:
when at least two of the multiple relevance weighted edges are jointly connected with one of the multiple sort nodes, retaining the relevance weighted edge with a greatest value among the at least two relevance weighted edges to establish the relationship between the under-test knowledge graph and the known knowledge graph group.

7. The establishment and comparison method as claimed in claim 5, wherein:
the multiple sort nodes of the multiple known knowledge graphs are connected through multiple common edges;
computing a temporary major sort node value of each known knowledge graph through values of the multiple relevance weighted edges, a value of each common edge, and a sort node algorithm;
determining a data transmitting direction according to a magnitude of the temporary major sort node value of each known knowledge graph, wherein:
the data transmitting direction is from a source knowledge graph to a sink knowledge graph; and
the known knowledge graph with the greater temporary major sort node value is defined as the source knowledge graph, and the known knowledge graph with the smaller temporary major sort node value is defined as the sink knowledge graph.

8. The establishment and comparison method as claimed in claim 7, further comprising:
updating the value of each sort node in the sink knowledge graph according to the data transmitting direction; and
computing the major sort node value of the sink knowledge graph according to the value of each sort node in the sink knowledge graph and the sort node algorithm, and defining the temporary major sort node value of the source knowledge graph as the major sort node value.

9. The establishment and comparison method as claimed in claim 7, wherein:
one terminal of each common edge is connected with a source node, and the other terminal of each common edge is connected with a sink node;
the sort node in the source knowledge graph is the source node, and the sort node in the sink knowledge graph is the sink node; and
the value of the sink node is the value of the source node multiplied by the value of the common edge connected with the source node and the sink node.

10. The establishment and comparison method as claimed in claim 7, wherein:
the multiple sort nodes in each known knowledge graph are connected through multiple sort weighted edges;
when one of the multiple sort nodes is connected with one terminal of the sort weighted edge and one terminal of the relevance weighted edge at the same time, a value of the sort node is the greater one of a sort product and a relevance product; and
wherein the sort product is the value of the sort weighted edge multiplied by the value of the sort node connected with the other terminal of the sort weighted edge, and the relevance product is the value of the relevance weighted edge multiplied by the value of the property node connected with the other terminal of the relevance weighted edge.
